(19) United States
(12) Patent Application Publication
(10) Pub. No.: US 2026/0332385 A1
(43) Pub. Date: Oct. 22, 2026

(54) APPARATUS AND METHOD FOR ENHANCING SECURITY USING BLIND QUANTUM COMPUTING

(71) Applicant: ELECTRONICS AND TELECOMMUNICATIONS RESEARCH INSTITUTE, Daejeon (KR)

(72) Inventors: Do-Young CHUNG, Daejeon (KR); You-Sung KANG, Daejeon (KR); Jeong-Nyeo KIM, Daejeon (KR); Ju-Young KIM, Daejeon (KR); Young-Kyung LEE, Daejeon (KR)

(21) Appl. No.: 19/534,589

(22) Filed: Feb. 9, 2026

(30) Foreign Application Priority Data
Apr. 22, 2025 (KR) 10-2025-0052327

(51) Int. Cl. H04L 9/00; G06N 10/20; G06N 10/60

(52) U.S. Cl. CPC H04L 9/008; G06N 10/20; G06N 10/60

(57) ABSTRACT

Disclosed herein is an apparatus and method for enhancing security using blind quantum computing. The apparatus performs an operation of a plaintext-state quantum circuit containing predefined information in a first quantum circuit to which a blind quantum computing technique is applied, performs a quantum homomorphic encryption operation on the output value of the first quantum circuit through a second quantum circuit connected to the output end of the first quantum circuit, performs an operation of a decryption operation circuit for the output value of the second quantum circuit and an operation of the plaintext-state quantum circuit in a third quantum circuit to which the blind quantum computing technique is applied, and outputs a value obtained by performing a quantum homomorphic encryption operation on the output value of the third quantum circuit through a fourth quantum circuit connected to the output end of the third quantum circuit.

### CROSS REFERENCE TO RELATED APPLICATION

This application claims the benefit of Korean Patent Application No. 10-2025-0052327, filed Apr. 22, 2025, which is hereby incorporated by reference in its entirety into this application.

### BACKGROUND OF THE INVENTION

### 1. Technical Field

The present disclosure relates generally to quantum computing technology, and more particularly to technology for enhancing security using blind quantum computing.

### 2. Description of the Related Art

Quantum computing has enormous parallel processing capability compared to classical computing, holding the potential to efficiently solve highly complex problems. However, with advances in quantum computing, data security has also emerged as a significant challenge, and it is expected that for a considerable period, quantum computers will not be personally owned but accessed via cloud and quantum computing providers to delegate computations to external quantum servers. As a result, users inevitably expose their input/output data and quantum circuits to third parties, and because most quantum algorithms, such as Grover's and Shor's algorithms, embed the function that a user intends to execute or the user's input values directly within the quantum circuit, techniques that conceal not only the input/output but also the quantum circuit itself are required. When security is weak, the risk of data leakage increases, thereby threatening the confidentiality of sensitive information. For these reasons, the Blind Quantum Computing (BQC) technique has been primarily used.

Blind quantum computing is a powerful security technique that enables users to securely input their data into a quantum server and obtain computation results. However, when blind quantum computing is applied to an entire circuit, it significantly degrades computational efficiency. Therefore, there is a need for an efficient alternative that can protect sensitive information while maintaining system performance.

Meanwhile, U.S. Patent Application Publication US2021/0058244, titled “The one-qubit pad (oqp) for entanglement encryption of quantum information” discloses a method for encrypting quantum information in an information-theoretically secure manner by using only a single qubit as a key.

### SUMMARY OF THE INVENTION

An object of the present disclosure is to provide a method for maximizing overall system efficiency while protecting sensitive information in a quantum computing environment.

Another object of the present disclosure is to enhance security by selectively applying a blind quantum computing technique to core parts of a quantum circuit that contains sensitive information and to enable efficient computation in the remaining parts of the circuit so as to minimize system performance degradation.

In order to accomplish the above objects, an apparatus for enhancing security using blind quantum computing according to an embodiment of the present disclosure includes one or more processors and memory for storing at least one program executed by the one or more processors, and the at least one program may perform an operation of a plaintext-state quantum circuit containing predefined information in a first quantum circuit to which a blind quantum computing technique is applied, perform a quantum homomorphic encryption operation on an output value of the first quantum circuit through a second quantum circuit connected to an output end of the first quantum circuit, perform an operation of a decryption operation circuit for an output value of the second quantum circuit and an operation of the plaintext-state quantum circuit in a third quantum circuit to which the blind quantum computing technique is applied, and output a value obtained by performing a quantum homomorphic encryption operation on an output value of the third quantum circuit through a fourth quantum circuit connected to an output end of the third quantum circuit.

Here, an output end of the second quantum circuit may be connected to an input end of the decryption operation circuit of the third quantum circuit.

Here, an output end of the decryption operation circuit of the third quantum circuit may be connected to an input end of the plaintext-state quantum circuit of the third quantum circuit.

Here, the quantum homomorphic encryption operation may comprise performing any one of a bit-flip operation and a phase-flip operation.

Here, the at least one program may repeatedly perform the operations applied to the third quantum circuit and the fourth quantum circuit a preset number of times.

Here, the at least one program may measure qubits the preset number of times, thereby obtaining a target quantum state.

Here, the plaintext-state quantum circuits of the first and third quantum circuits are configured as oracle circuits, and the second and fourth quantum circuits are configured as diffusion operation circuits, whereby Grover's algorithm may be applied.

Also, in order to accomplish the above objects, a method for enhancing security using blind quantum computing, each step of which is performed by an apparatus for enhancing security using blind quantum computing, according to an embodiment of the present disclosure includes performing an operation of a plaintext-state quantum circuit containing predefined information in a first quantum circuit to which a blind quantum computing technique is applied, performing a quantum homomorphic encryption operation on an output value of the first quantum circuit through a second quantum circuit connected to an output end of the first quantum circuit, performing an operation of a decryption operation circuit for an output value of the second quantum circuit and an operation of the plaintext-state quantum circuit in a third quantum circuit to which the blind quantum computing technique is applied, and outputting a value obtained by performing a quantum homomorphic encryption operation on an output value of the third quantum circuit through a fourth quantum circuit connected to an output end of the third quantum circuit.

Here, an output end of the second quantum circuit may be connected to an input end of the decryption operation circuit of the third quantum circuit.

Here, an output end of the decryption operation circuit of the third quantum circuit may be connected to an input end of the plaintext-state quantum circuit of the third quantum circuit.

Here, the quantum homomorphic encryption operation may comprise performing any one of a bit-flip operation and a phase-flip operation.

Here, outputting the value may comprise repeatedly performing the operations applied to the third quantum circuit and the fourth quantum circuit a preset number of times.

Here, outputting the value may comprise measuring qubits the preset number of times, thereby obtaining a target quantum state.

Here, the plaintext-state quantum circuits of the first and third quantum circuits are configured as oracle circuits, and the second and fourth quantum circuits are configured as diffusion operation circuits, whereby Grover's algorithm may be applied.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a view illustrating a system for enhancing security using blind quantum computing according to an embodiment of the present disclosure;

FIG. 2 is a view illustrating a quantum circuit in which Grover's algorithm is applied to a security enhancement method using blind quantum computing according to an embodiment of the present disclosure;

FIG. 3 is a flowchart illustrating a security enhancement management method using blind quantum computing according to an embodiment of the present disclosure; and

FIG. 4 is view illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

Throughout this specification, the terms “comprises” and/or “comprising” and “includes” and/or “including” specify the presence of stated elements but do not preclude the presence or addition of one or more other elements unless otherwise specified.

Hereinafter, a preferred embodiment of the present disclosure will be described in detail with reference to the accompanying drawings.

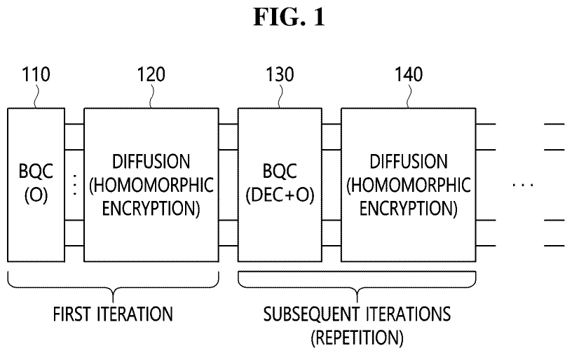

FIG. 1 is a view illustrating a quantum circuit to which a security enhancement method using blind quantum computing is applied according to an embodiment of the present disclosure.

Referring to FIG. 1, the quantum circuit to which a security enhancement method using blind quantum computing is applied according to an embodiment of the present disclosure may be divided into the following two parts.

Type 1 is a portion that contains sensitive information, and Blind Quantum Computing (BQC) is applied thereto such that the circuit is not exposed.

Type 2 is a portion of the circuit that is exposed, excluding Type 1.

The security enhancement method using blind quantum computing according to an embodiment of the present disclosure may protect the portion of the quantum circuit containing sensitive information by applying blind quantum computing (Type 1) and may connect the Type 1 circuit with the portion that does not contain sensitive information (Type 2).

The security enhancement method using blind quantum computing according to an embodiment of the present disclosure may prevent not only the quantum circuit but also sensitive information, such as output values, etc., from being exposed during the computation process.

The Type 1 circuit applies BQC to the portion of the quantum circuit that includes the function that a user intends to execute or the user's input values, thereby preventing the sensitive information from being exposed from the quantum circuit.

BQC is based on Measurement-Based Quantum Computing (MBQC). Due to the constraint that most quantum computer hardware operates based on gates, BQC generally operates by being converted into a gate-based form, and the quantum resources (qubits and gates) used in this process may increase.

Accordingly, the present disclosure applies BQC only to the portion (Type 1) in which the sensitive information contained in the circuit needs to be protected, and seeks to pursue efficiency in the other portion (Type 2). To this end, the following considerations need to be taken into account in the process of connecting the Type 1 circuit and the Type 2 circuit.

A qubit, which is a basic unit of quantum computing, is configured with a value obtained through measurement (similar to a bit in digital computing) and a phase that cannot be directly observed but affects computation. The Type 1 and Type 2 circuits to which different security techniques are applied are configured to apply bit and phase transformations (primarily flip operations causing a bit flip of 0→1 or 1→0 and a phase shift of π) to input/output (especially output). If qubits to which such transformations are applied are used in another quantum circuit without special processing, an unexpected result is output. Also, when the bit and phase transformations are recovered to use the qubits in another quantum circuit, this corresponds to a kind of decryption. Therefore, the intended result value may be obtained, but it exposes the computation process and the result in plaintext to an untrusted quantum server that performs the operation. In other words, the key challenge is enabling the result to be utilized in another circuit without exposing the plaintext to the quantum server.

To this end, the following characteristics are used. Applying a bit-flip (X gate) or a phase-flip (Z gate) to each qubit depending on a digital bit is a technique that is the foundation of security techniques in a quantum computing environment. When using a digital bit string as a key and applying a bit-flip or a phase-flip based on the key, a quantum server that does not know the key cannot determine the plaintext state of qubits.

In the present disclosure, these bit-flip and phase-flip operations are applied to the front part (input stage) of the Type 2 circuit, and decryption based on the key is performed at the back part (output stage), whereby the input/output values may be protected (here, unlike Type 1, the quantum circuit of Type 2 itself is exposed). Here, an important point is that the output value of the Type 1 circuit (the quantum circuit to which BQC is applied) is also in the state in which a bit-flip and a phase-flip are selectively applied, and information about whether they are applied is possessed by a client as a key that is digital bits for restoring the result value in the BQC process. That is, the output value of the Type 1 circuit is in an encrypted state through selective application of a bit-flip and a phase-flip, and the client possesses the digital bits for decryption as a key.

In the present disclosure, the application of bit-flips and phase-flips to the front part (input stage) of the Type 2 circuit has been already completed by the same operation at the output stage of the Type 1 circuit, and this corresponds to the process of connecting the output stage 110 of the Type 1 circuit to the input stage 120 of the Type 2 circuit in FIG. 1.

The Type 2 circuit 120, compared to the Type 1 circuit 110, may maintain the existing circuit form, excluding some gates (non-Clifford gates), by applying existing research results (quantum homomorphic encryption (e.g., Fisher, K., Broadbent, A., Shalm, L. et al., Quantum computing on encrypted data. Nat. Commun 5, 3074 (2014). https://doi.org/10.1038/ncomms4074)), and non-Clifford gates may also be relatively easily implemented.

Next, when the Type 1 circuit and the Type 2 circuit occur multiple times (e.g., (Type 1 circuit #1)→(Type 2 circuit #1)→(Type 1 circuit #2)→ . . . ), it is necessary to consider the process of connecting the output stage of the Type 2 circuit to the input stage of the Type 1 circuit.

When the Type 1 circuit 110, that is, the plaintext circuit O to which BQC is to be applied, is present, BQC(O) is defined as the circuit to which BQC is applied. When DEC indicates the circuit for decrypting the output value from the preceding Type 2 circuit 120, the BQC(DEC+O) circuit 130 may be deployed by applying BQC to a circuit in which the circuit DEC is placed before the circuit O. The untrusted quantum server has no knowledge of DEC and O. Here, DEC may be implemented in various manners based on existing research results (e.g., Fisher, K., Broadbent, A., Shalm, L. et al., Quantum computing on encrypted data. Nat Commun. 5, 3074 (2014). https://doi.org/10.1038/ncomms4074), and the additional quantum resources (qubits and gates) incurred by DEC are relatively negligible, compared to O.

Also, in the BQC operation process, the client and the server interact through digital communication for each qubit, and the client determines the operation to be performed on the next qubit and notifies the server of the operation. BQC may be performed by flexibly reflecting changes in whether to apply a bit-flip (X gate) and a phase-flip (Z gate) in the decryption circuit (DEC) for the output value of the Type 2 circuit that is affected by the value of the input stage of the Type 2 circuit (the output value of the preceding Type 1 circuit).

Accordingly, the overall circuit form may be described as follows.

When it is not necessary to protect the input value of the entire quantum circuit: Type 1 circuit (BQC (O_1))→Type 2 circuit_1→Type 1 circuit (BQC(DEC_1+O_2))→Type 2 circuit_2→ . . . →final result.

When the input qubits are encrypted by applying bit-flips and phase-flips in order to protect the input value of the entire quantum circuit: Type 1 circuit (BQC(DEC_1+O_1))→Type 2 circuit_1→Type 1 circuit (BQC(DEC_2+O_2))→Type 2 circuit_2→ . . . →final result.

The final result is output in the state in which a bit-flip or a phase-flip is selectively applied in the previous circuit, and the client holds the key in the form of digital bits. Accordingly, the client may utilize the final result in two manners.

When the measurement values (0 or 1) of the final result are required, the server may perform measurement and transmit the result to the client in the form of digital bits.

Here, the measurement value for the qubit to which a bit-flip is applied is generated with the opposite sign (0→1, 1→0), and because the client receiving the measurement value knows the locations where the bit-flip occurs, the client may easily obtain the intended value (plaintext).

When the final result needs to be utilized in a quantum state, the server may transmit the qubits corresponding to the final result to the client, without measuring the same. Because the client receiving the qubits knows whether a bit-flip and a phase-flip are selectively applied, the client may change the state to the desired quantum state (plaintext qubits) by using X gates and Z gates.

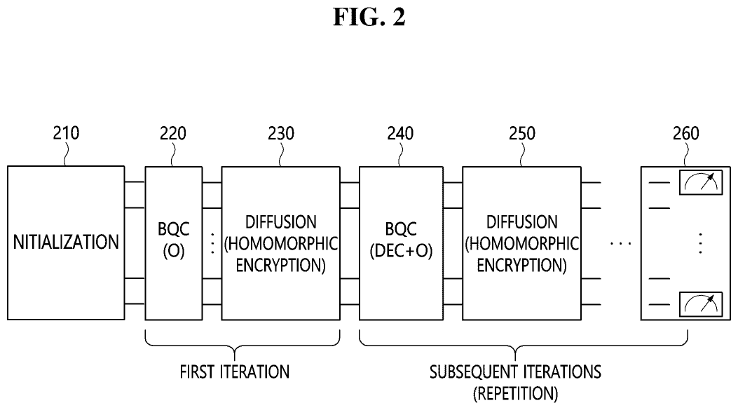

FIG. 2 is a view illustrating a quantum circuit in which Grover's algorithm is applied to a security enhancement method using blind quantum computing according to an embodiment of the present disclosure.

Referring to FIG. 2, an embodiment in which Grover's algorithm is applied to the security enhancement method using blind quantum computing according to an embodiment of the present disclosure is presented. Grover's algorithm is an algorithm for finding x₀ satisfying f(x₀)=1 in a search space of 2\hat{ }n possible answers represented by n bits (f(x)=0 for all other x values) and includes the following phases.

In the initialization phase, all qubits are initialized to the |0 [symbol] state, and then a Hadamard gate is applied to generate an initial state with uniform probability.

In the oracle application phase, the oracle operation, which contains information required to identify f and x₀, may be performed.

In the diffusion operation phase, an operation that reflects each state about the average of the total state may be performed.

In the measurement phase, after repeating the oracle application phase and the diffusion operation phase for the required number of iterations, the qubits are measured to obtain the target state x₀.

In order to apply the technique of the present disclosure, the circuit may be divided as follows.

Type 1 circuit is the oracle circuit and contains information for finding f and x₀, which is regarded as sensitive information, so BQC is applied for protection.

Type 2 circuit includes non-oracle components, such as initialization, diffusion operations, and the like, and does not contain information related to f and x₀ that Grover's algorithm intends to find, so the circuit may be exposed.

By applying the technique of the present disclosure, the Grover's algorithm quantum circuit may be constructed as follows.

The initialization phase may be maintained as the same as that of the existing Grover's algorithm quantum circuit.

In the oracle circuit (Type 1 ) for the first iteration, because the qubit state of the preceding phase is plaintext, BQC is applied only to the oracle circuit to generate BQC(O).

The diffusion circuit (Type 2 ) for the first and subsequent iterations may be implemented by applying the existing homomorphic encryption quantum circuit (e.g., Fisher, K., Broadbent, A., Shalm, L. et al. Quantum computing on encrypted data. Nat Commun 5, 3074 (2014). https://doi.org/10.1038/ncomms4074) to the existing diffusion circuit of Grover's algorithm.

In the oracle circuit (Type 1 ) for the second and subsequent iterations, because the qubit state entering as input is in an encrypted state, a DEC circuit is placed before the plaintext oracle circuit O, and BQC is applied to the DEC+O circuit to generate BQC(DEC+O).

The output of the diffusion circuit in the final iteration of the measurement phase is in the state in which bit-flips and phase-flips are selective applied. As in the technique of the present disclosure, when measurement values are required, the measurement values are transmitted to the client, whereas when the quantum state is required, the qubits are transmitted to the client such that the client performs the necessary decryption.

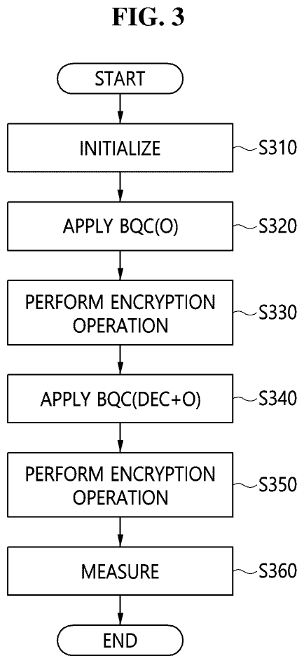

FIG. 3 is a flowchart illustrating a method for enhancing security using blind quantum computing according to an embodiment of the present disclosure.

Referring to FIG. 3, in the method for enhancing security using blind quantum computing according to an embodiment of the present disclosure, first, initialization may be performed at step S310.

That is, at step S310, a measurement value or an input value for quantum state measurement may be input to a plaintext-state quantum circuit in which all qubits are initialized to the |0 [symbol] state.

Here, at step S310, in the case of Grover's algorithm, a Hadamard gate may be applied to generate an initial state with uniform probability.

Also, in the method for enhancing security using blind quantum computing according to an embodiment of the present disclosure, BQC(O) may be applied at step S320.

That is, at step S320, in a first quantum circuit to which a blind quantum computing technique is applied, an operation of a plaintext-state quantum circuit that contains predefined information may be performed.

Here, at step S320, the blind quantum computing technique is applied to the first quantum circuit containing predefined sensitive information, whereby a quantum circuit to which BQC(O) is applied may be generated.

Here, at step S320, a bit-flip (X gate) operation and a phase-flip (Z gate) operation may be additionally applied to the first quantum circuit.

Here, at step S320, when encryption is performed by applying any one of a bit-flip (X gate) operation and a phase-flip (Z gate) operation to input qubits in order to protect the input value of the entire quantum circuit, a DEC circuit is placed before the plaintext-state quantum circuit to form a DEC+O circuit, and BQC is applied thereto, whereby BQC(DEC+O) may be generated.

Also, in the method for enhancing security using blind quantum computing according to an embodiment of the present disclosure, a diffusion operation may be performed at step S330.

That is, at step S330, a quantum homomorphic encryption operation may be performed on the output value of the first quantum circuit through a second quantum circuit connected to the output end of the first quantum circuit.

The quantum homomorphic encryption operation may comprise performing any one of a bit-flip operation and a phase-flip operation.

Here, at step S330, in the case of Grover's algorithm, a diffusion operation that reflects each state about the average of the total state may be performed.

Also, in the method for enhancing security using blind quantum computing according to an embodiment of the present disclosure, BQC(DEC+O) may be applied at step S340.

That is, at step S340, in a third quantum circuit to which the blind quantum computing technique is applied, the operation of a decryption operation circuit for the output value of the second quantum circuit and the operation of the plaintext-state quantum circuit may be performed.

Here, at step S340, BQC is applied to a DEC+O circuit in which a DEC operation circuit is placed before the plaintext-state quantum circuit in order to decrypt the output value of the second quantum circuit, whereby BQC(DEC+O) may be generated.

The output end of the second quantum circuit may be connected to the input end of the decryption operation circuit of the third quantum circuit.

Here, the output end of the decryption operation circuit of the third quantum circuit may be connected to the input end of the plaintext-state quantum circuit of the third quantum circuit.

Also, in the method for enhancing security using blind quantum computing according to an embodiment of the present disclosure, a diffusion operation may be performed at step S350.

That is, at step S350, the quantum homomorphic encryption operation applied to the diffusion circuit may be performed.

Also, in the method for enhancing security using blind quantum computing according to an embodiment of the present disclosure, measurement may be performed at step S360.

That is, at step S360, a value obtained by performing the quantum homomorphic encryption operation on the output value of the third quantum circuit through a fourth quantum circuit connected to the output end of the third quantum circuit may be output.

Here, at step S360, the output value to which the quantum homomorphic encryption is applied (at least one of measurement values, or qubits, or a combination thereof) is transmitted to a client such that decryption is performed.

Here, at step S360, the operations applied to the third quantum circuit and the fourth quantum circuit at steps S340 and S350 may be repeatedly performed a preset number of times.

Here, at step S360, the qubits are measured the preset number of times through steps S340 and S350, whereby a target quantum state may be obtained.

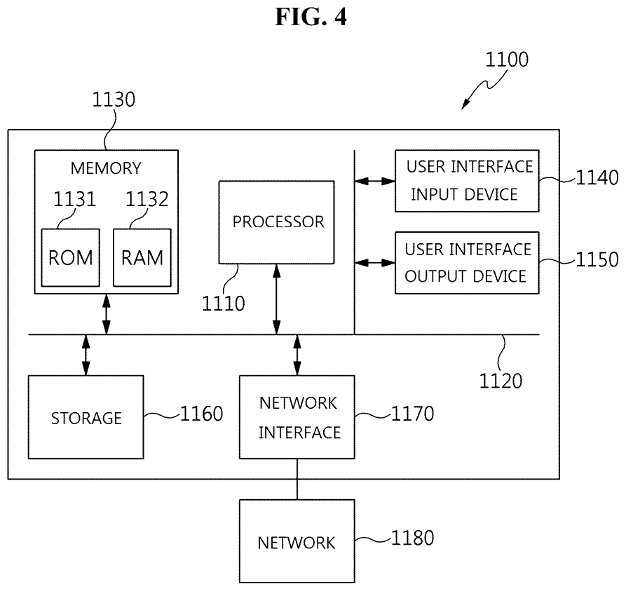

FIG. 4 is a view illustrating a computer system according to an embodiment of the present disclosure.

Referring to FIG. 4, the apparatus for enhancing security using blind quantum computing according to an embodiment of the present disclosure may be implemented in a computer system 1100 including a computer-readable recording medium. As illustrated in FIG. 4, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

Also, the apparatus for enhancing security using blind quantum computing according to an embodiment of the present disclosure may include all types of apparatuses, devices, and machines for processing digital and/or quantum data, as well as a programmable digital processor, a programmable quantum processor, a digital computer, a quantum computer, multiple digital and quantum processors or computers, and a combination thereof. This apparatus may also be or further include special-purpose logic circuitry, for example, a field-programmable gate array (FPGA), an application-specific integrated circuit (ASIC), or a quantum simulator, i.e., a quantum data processing device designed to simulate or generate information about a specific quantum system. In particular, the quantum simulator is a special-purpose quantum computer that does not have the capability to perform general-purpose quantum computation. The apparatus may optionally include code for generating an execution environment for digital and/or quantum computer programs by being added to hardware, for example, code constituting processor firmware, a protocol stack, a database management system, an operating system, or a combination of one or more selected therefrom.

The apparatus for enhancing security using blind quantum computing according to an embodiment of the present disclosure includes one or more processors 1110 and memory 1130 for storing at least one program executed by the one or more processors 1110, and the at least one program may perform an operation of a plaintext-state quantum circuit containing predefined information in a first quantum circuit to which a blind quantum computing technique is applied, perform a quantum homomorphic encryption operation on the output value of the first quantum circuit through a second quantum circuit connected to the output end of the first quantum circuit, perform an operation of a decryption operation circuit for the output value of the second quantum circuit and an operation of the plaintext-state quantum circuit in a third quantum circuit to which the blind quantum computing technique is applied, and output a value obtained by performing a quantum homomorphic encryption operation on the output value of the third quantum circuit through a fourth quantum circuit connected to the output end of the third quantum circuit.

Here, the output end of the second quantum circuit may be connected to the input end of the decryption operation circuit of the third quantum circuit.

Here, the output end of the decryption operation circuit of the third quantum circuit may be connected to the input end of the plaintext-state quantum circuit of the third quantum circuit.

Here, the quantum homomorphic encryption operation may comprise performing any one of a bit-flip operation and a phase-flip operation.

Here, the at least one program may repeatedly perform the operations applied to the third and fourth quantum circuits a preset number of times.

Here, the at least one program may obtain a target quantum state by measuring qubits the preset number of times.

Here, the plaintext-state quantum circuits of the first and third quantum circuits are configured as oracle circuits, and the second and fourth quantum circuits are configured as diffusion circuits, whereby Grover's algorithm may be applied.

The present disclosure may provide a method for maximizing overall system efficiency while protecting sensitive information in a quantum computing environment.

Also, the present disclosure may enhance security by selectively applying a blind quantum computing technique to core parts of a quantum circuit that contains sensitive information, and it enables efficient computation in the remaining parts of the circuit, thereby minimizing system performance degradation.

As described above, the apparatus and method for enhancing security using blind quantum computing according to the present disclosure are not limitedly applied to the configurations and operations of the above-described embodiments, but all or some of the embodiments may be selectively combined and configured, so the embodiments may be modified in various ways.

What is claimed is:

1. An apparatus for enhancing security using blind quantum computing, comprising:
one or more processors; and
memory for storing at least one program executed by the one or more processors,
wherein the at least one program performs an operation of a plaintext-state quantum circuit containing predefined information in a first quantum circuit to which a blind quantum computing technique is applied,
performs a quantum homomorphic encryption operation on an output value of the first quantum circuit through a second quantum circuit connected to an output end of the first quantum circuit,
performs an operation of a decryption operation circuit for an output value of the second quantum circuit and an operation of the plaintext-state quantum circuit in a third quantum circuit to which the blind quantum computing technique is applied, and
outputs a value obtained by performing a quantum homomorphic encryption operation on an output value of the third quantum circuit through a fourth quantum circuit connected to an output end of the third quantum circuit.

2. The apparatus of claim 1, wherein an output end of the second quantum circuit is connected to an input end of the decryption operation circuit of the third quantum circuit.

3. The apparatus of claim 2, wherein an output end of the decryption operation circuit of the third quantum circuit is connected to an input end of the plaintext-state quantum circuit of the third quantum circuit.

4. The apparatus of claim 1, wherein the quantum homomorphic encryption operation comprises performing any one of a bit-flip operation and a phase-flip operation.

5. The apparatus of claim 1, wherein the at least one program repeatedly performs the operations applied to the third quantum circuit and the fourth quantum circuit a preset number of times.

6. The apparatus of claim 5, wherein the at least one program measures qubits the preset number of times, thereby obtaining a target quantum state.

7. The apparatus of claim 1, wherein the plaintext-state quantum circuits of the first and third quantum circuits are configured as oracle circuits, and the second and fourth quantum circuits are configured as diffusion operation circuits, whereby Grover's algorithm is applied.

8. A method for enhancing security using blind quantum computing, each step of which is performed by an apparatus for enhancing security using blind quantum computing, the method comprising:
performing an operation of a plaintext-state quantum circuit containing predefined information in a first quantum circuit to which a blind quantum computing technique is applied;
performing a quantum homomorphic encryption operation on an output value of the first quantum circuit through a second quantum circuit connected to an output end of the first quantum circuit;
performing an operation of a decryption operation circuit for an output value of the second quantum circuit and an operation of the plaintext-state quantum circuit in a third quantum circuit to which the blind quantum computing technique is applied; and
outputting a value obtained by performing a quantum homomorphic encryption operation on an output value of the third quantum circuit through a fourth quantum circuit connected to an output end of the third quantum circuit.

9. The method of claim 8, wherein an output end of the second quantum circuit is connected to an input end of the decryption operation circuit of the third quantum circuit.

10. The method of claim 9, wherein an output end of the decryption operation circuit of the third quantum circuit is connected to an input end of the plaintext-state quantum circuit of the third quantum circuit.

11. The method of claim 8, wherein the quantum homomorphic encryption operation comprises performing any one of a bit-flip operation and a phase-flip operation.

12. The method of claim 8, wherein outputting the value comprises repeatedly performing the operations applied to the third quantum circuit and the fourth quantum circuit a preset number of times.

13. The method of claim 12, wherein outputting the value comprises measuring qubits the preset number of times, thereby obtaining a target quantum state.

14. The method of claim 8, wherein the plaintext-state quantum circuits of the first and third quantum circuits are configured as oracle circuits, and the second and fourth quantum circuits are configured as diffusion operation circuits, whereby Grover's algorithm is applied.
